(19) United States
(12) Patent Application Publication
(10) Pub. No.: US 2026/0219818 A1
(43) Pub. Date: Jul. 30, 2026

(54) PRINTER SYSTEM THAT AUTHENTICATES USERS BASED ON LOCATION INFORMATION

(71) Applicant: Toshiba Tec Kabushiki Kaisha, Tokyo (JP)

(72) Inventors: Farnaz SHAHVIR, Rancho Santa Margarita, CA (US); Maziar M. BASTANI, Rancho Santa Margarita, CA (US)

(21) Appl. No.: 19/041,810

(22) Filed: Jan. 30, 2025

(51) Int. Cl. G06F 3/12; H04W 4/029

(52) U.S. Cl. CPC G06F 3/1238; G06F 3/1222; G06F 3/1285; H04W 4/029

(57) ABSTRACT

A printer management computer is configured to enable a user to execute a print job or copy job based on location information, by performing the steps of: receiving, from a printer, a request to authenticate the user whose access card has been presented at the printer; determining one of: (1) that a first distance between a mobile device of the user and the printer is greater than a threshold or (2) that a second distance between the mobile device and the access card is greater than the threshold; transmitting, to the mobile device in response to the first or second distance being greater than the threshold, a message requesting authorization for using the access card, and then receiving a response indicating that authorization for using the access card is granted; and transmitting, to the printer, a message indicating that execution of the print job or copy job is authorized.

### FIELD

Embodiments to be described herein generally relate to a printer management computer configured to carry out steps for enabling a user to execute a print job or copy job based on location information, a method comprising such steps, and a non-transitory computer-readable medium comprising instructions that cause a printer management computer to carry out such steps.

### BACKGROUND

With some printer services, users may scan access cards at printers to unlock the printers. Then, as long as the access cards are registered with the printer services, the users can use the printers. However, in some cases, further authentication of users is desired before allowing such usage of the printers. For example, if a user's access card is stolen, the user's card may be used fraudulently, e.g., for executing several print jobs or copy jobs. There is thus a desire for adding an extra layer of authentication for preventing such fraudulent usage.

### BRIEF DESCRIPTION OF THE DRAWINGS

FIG. 1 is a block diagram of a computer system in which embodiments may be implemented.

FIG. 2 is a flow diagram of a method that may be performed by a printer and a printer management computer of the computer system to determine location information for authenticating a user, according to a first embodiment.

FIG. 3 is a flow diagram of a method that may be performed by the printer, the printer management computer, and a mobile device of the user to determine location information for authenticating the user, according to a second embodiment.

FIG. 4 is a flow diagram of a method that may be performed by the printer, printer management computer, and mobile device to manage the execution of jobs, according to embodiments.

### DETAILED DESCRIPTION

One or more embodiments provide a printer management computer including a processor and memory, wherein the processor executes instructions stored in the memory to enable a user to execute a print job or copy job based on location information. The printer management computer performs the steps of: receiving, from a printer, a request to authenticate the user whose access card has been presented at the printer; determining, in response to the request to authenticate the user, one of: (1) that a first distance between a mobile device of the user and the printer is greater than a threshold or (2) that a second distance between the mobile device and the access card is greater than the threshold; transmitting, to the mobile device in response to the first or second distance being greater than the threshold, a message requesting authorization for using the access card to access the printer, and then receiving a response from the mobile device indicating that authorization for using the access card is granted; and transmitting, to the printer in response to authorization being granted for using the access card, a message indicating that execution of the print job or copy job is authorized.

As used herein, “printer” may refer to a multifunction printer (MFP), which is a device with multiple capabilities such as executing print jobs, copy jobs, scan jobs, and fax jobs, and “printer” may also refer to a standard printer that only includes capabilities for executing print jobs. A print job is a task to print a document or image, and a print job includes settings such as whether to print in color or in black and white. A copy job is a task to make a copy of a document or image, and a copy job includes settings such as a number of copies to make. A scan job is a task to convert a physical document or image into a digital format, and a scan job includes settings such as a file format for the converted document or image. A fax job is a task to transmit or receive a document or image electronically, e.g., over a telephone line or over the Internet, and a fax job includes settings such as a resolution for a transmitted document or image.

According to a first embodiment, the printer management computer determines whether to authenticate a user based on a distance between the user's mobile device and the printer. According to a second embodiment, the printer management computer makes this determination based on a distance between the user's mobile device and the user's access card. As used herein, an “access card” is a card that may be presented at a device such as a printer to gain access to capabilities of the device such as print, copy, scan, and fax capabilities. As just some examples, the access card may be a radio frequency identification (RFID) card that the user taps near an RFID reader on the printer, a magnetic stripe card that the user swipes through a magnetic stripe reader on the printer, a smart card that the user inserts into a smart card reader on the printer, a barcode card that the user scans using a barcode scanner on the printer, etc.

According to the first embodiment, if the distance between the mobile phone and printer is greater than a threshold, it may indicate that the user's card is being used fraudulently. Similarly, according to the second embodiment, if the distance between the mobile device and the access card is greater than the threshold, it may indicate that the user's card is being used fraudulently. According to embodiments, if such location information indicates possible fraudulent usage, the printer management computer notifies the user and requests for the user to authorize usage of the access card to access the printer. If the user authorizes the usage, the printer management computer notifies the printer to unlock and allow for execution, e.g., of print jobs or copy jobs.

Embodiments present a user the opportunity to prevent fraudulent usage of their access card when the user is far away from a printer at which their access card is presented. Furthermore, embodiments are efficient, requiring little intervention from legitimate users. If the location information indicates possible fraudulent usage, a user merely responds to an alert from the printer management computer, e.g., by pressing a button on a user interface (UI) of their mobile device. On the other hand, if the location information does not indicate fraudulent usage, the authentication does not add an extra step for the user to complete, i.e., the printer may be unlocked automatically without the user's intervention. Hereinafter, embodiments will be described with reference to the drawings. In the drawings, the same reference symbols denote the same or similar portions.

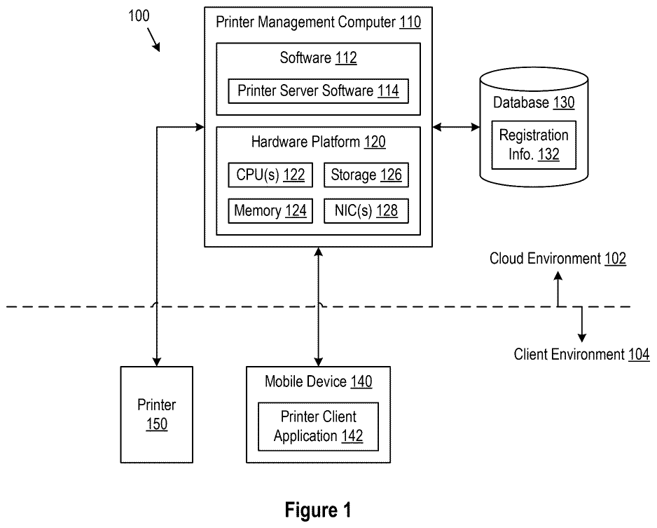

FIG. 1 is a block diagram of a computer system 100 in which embodiments may be implemented. Computer system 100 includes a cloud environment 102 and a client environment 104. For example, cloud environment 102 may be a data center of a private cloud in which infrastructure is provisioned for a single organization. As another example, cloud environment 102 may be a data center of a public cloud in which infrastructure is provisioned for several users and organizations. Client environment 104 may be, e.g., a workplace of an organization at which a plurality of employees access one or more printers.

Cloud environment 102 includes a printer management computer 110 and a database 130. Printer management computer 110 is a computer used for managing a printer service associated with a printer 150 of client environment 104. Printer management computer 110 is accessed remotely, e.g., by an organization of client environment 104. For example, printer management computer 110 may be a server computer. Printer management computer 110 is constructed on a hardware platform 120 such as an x86 architecture platform.

Hardware platform 120 includes components of a computer, such as one or more central processing units (CPUs) 122, memory 124 such as random-access memory (RAM), local storage 126 such as one or more magnetic drives or solid-state drives (SSDs), and one or more network interface controllers (NICs) 128. CPU(s) 122 are configured to execute instructions such as executable instructions that perform one or more operations described herein, which may be stored in memory 124. Computer 110 may communicate with other devices such as a mobile device 140 and printer 150 of client environment 104, over a network such as the Internet.

Hardware platform 120 supports software 112 such as a printer server software 114. Printer server software 114 is the printer service accessed, e.g., by the organization of client environment 104. For example, printer server software 114 may be a cloud-based printing software such as e-BRIDGE® Global Print, available from Toshiba Tec Corp. Printer management computer 110 uses printer server software 114 to manage a database 130. Database 130 is a structured collection of data that may be stored externally from management computer 110, e.g., on one or more magnetic drives or SSDs of a storage array. As another example, although illustrated as being external to management computer 110, database 130 may be stored in storage 126 of hardware platform 120.

Database 130 includes registration information 132 associated with registered clients (users) of printer server software 114. Registration information 132 includes information used for authenticating the registered users. For example, registration information 132 may include information for communicating with mobile devices used by registered users such as push notification information for sending push notifications, phone numbers for sending text messages, etc. As another example, registration information 132 may include information from access cards used by registered users such as numeric identifiers (IDs) from the access cards.

Client environment 104 includes mobile device 140 and printer 150. Mobile device 140 is a portable device used by a user of printer server software 114 such as a smartphone. Mobile device 140 includes printer client application 142, which is software that is configured for communicating with printer server software 114. Alternatively, or additionally, mobile device 140 may use a web browser (not shown) for communicating with printer server software 114. Printer 150 is, e.g., an MFP or a standard printer.

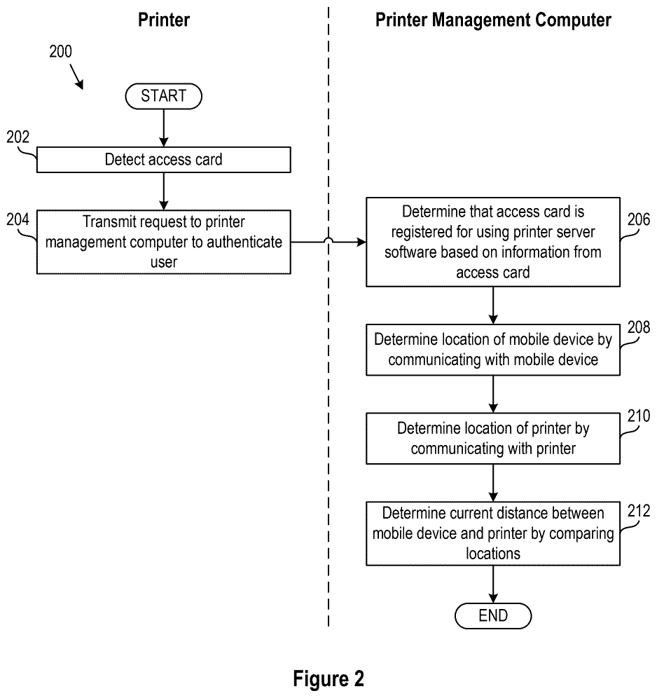

FIG. 2 is a flow diagram of a method 200 that may be performed by printer 150 and printer management computer 110 to determine location information for authenticating a user, according to the first embodiment. In the first embodiment, printer management computer 110 determines whether to authenticate the user based on a distance between mobile device 140 and printer 150. At step 202, printer 150 detects the access card being presented, e.g., near an RFID reader on printer 150, through a magnetic stripe reader on printer 150, in a smart card reader on printer 150, or at a barcode scanner on printer 150. At step 204, printer 150 transmits a request to printer management computer 110 to authenticate the user. Printer 150 includes, in the request, information from the access card such as an ID from the access card.

At step 206, printer management computer 110 determines that the access card is registered for using printer server software 114 based on the information from the access card. Printer management computer 110 may search registration information 132 for information matching the information from the access card to determine that the access card is registered. At step 208, in response to determining that the access card is registered, printer management computer 110 determines a location of mobile device 140 by communicating with mobile device 140. Through such communication, printer management computer 110 obtains location information such as a current latitude and longitude of mobile device 140. For example, printer client application 142 my prompt the user for permission for printer management computer 110 to access the location information. The user may then grant such permission by interacting with a UI of printer client application 142, e.g., by pressing a button in the UI.

Printer client application 142 may then send a message to printer server software 114 indicating that the user has authorized printer management computer 110 to access the location information. Printer management computer 110 may then access the location information to determine the location of mobile device 140. For example, mobile device 140 may periodically send the location information to printer management computer 110, e.g., while printer client application 142 is open. As another example, each time printer management computer 110 receives a request from printer 150 to authenticate the user, printer server software 114 may transmit a request for location information to mobile device 140, e.g., as a push notification. Mobile device 140 may then, in response to such requests, transmit the location information to printer management computer 110.

At step 210, printer management computer 110 determines a location of printer 150 by communicating with printer 150. Through such communication, printer management computer 110 obtains location information such as a current latitude and longitude of printer 150. For example, printer 150 may include the location information in the request to authenticate the user. As another example, printer 150 may periodically send the location information to printer management computer 110. At step 212, printer management computer 110 determines the current distance between mobile device 140 and printer 150 by comparing the locations of mobile device 140 and printer 150. After step 212, method 200 ends.

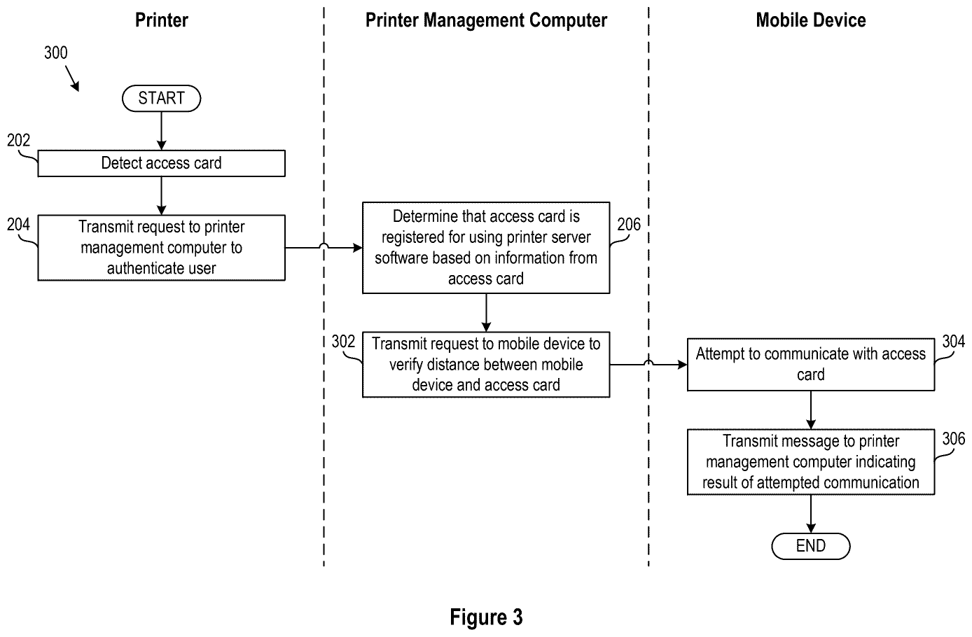

FIG. 3 is a flow diagram of a method 300 that may be performed by printer 150, printer management computer 110, and mobile device 140 to determine location information for authenticating a user, according to the second embodiment. In the second embodiment, printer management computer 110 determines whether to authenticate the user based on a distance between mobile device 140 and the user's access card. Steps that are the same or similar to steps of FIG. 2 have the same reference numbers and will not be explained again. After printer management computer 110 determines that an access card presented at printer 150 is registered, at step 302, printer management computer 110 transmits a request to mobile device 140. The request prompts mobile device 140 to verify a distance between mobile device 140 and the access card.

For example, printer management computer 110 may transmit the request as a push notification to a push notification service associated with printer client application 142, and the push notification service may route the message to printer client application 142. To enable printer management computer 110 to transmit push notifications to client application 142, printer client application 142 may prompt the user for permission for printer management computer 110 to send push notifications. The user may then grant such permission by interacting with a UI of printer client application 142, e.g., by pressing a button in the UI. Printer client application 142 may then send a message to printer server software 114 indicating that the user has authorized printer management computer 110 to send push notifications to printer client application 142. The message further includes push notification information such as a device registration token associated with printer client application 142.

At step 304, in response to the request, mobile device 140 attempts to communicate with the access card. For example, if the access card is an RFID card, mobile device 140 may emit a near field communication (NFC) signal. If the RFID card is close enough to receive the signal, the signal may power up the RFID card, and the RFID card may respond to mobile device 140 with information stored therein. Otherwise, if the RFID card is not close enough to receive the signal, the RFID card may not power up and thus may not transmit a response.

At step 306, mobile device 140 transmits a message to printer management computer 110 indicating a result of the attempted communication. For example, if mobile device 140 was successfully able to communicate with the access card, e.g., as indicated by mobile device 140 receiving a response to an emitted NFC signal, the message may indicate that the attempted communication was successful. On the other hand, if mobile device 140 was not able to communicate with the access card, e.g., as indicated by mobile device 140 not receiving a response, the message may indicate that the attempted communication was unsuccessful. It should be noted that steps 304 and 306 may be performed by printer client application 142 as background processes, i.e., without user intervention. After step 306, method 300 ends.

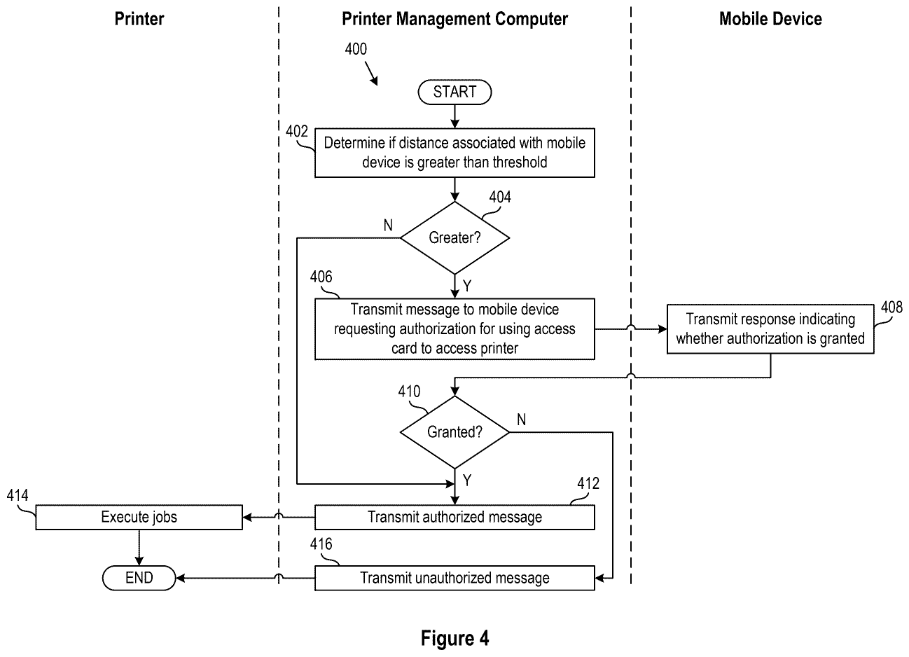

FIG. 4 is a flow diagram of a method 400 that may be performed by printer 150, printer management computer 110, and mobile device 140 to manage the execution of jobs, according to embodiments. At step 402, printer management computer 110 determines if a distance associated with mobile device 140 is greater than a threshold. According to the first embodiment, the distance is between mobile device 140 and printer 150. Printer management computer 110 may compare such distance to a threshold distance such as 10 feet to determine if the distance is greater than the threshold.

According to the second embodiment, the distance is between mobile device 140 and an access card presented at printer 150. For example, if mobile device 140 is not able to communicate with the access card, printer management computer 110 may determine that the distance is greater than the threshold. Otherwise, if mobile device 140 is able to communicate with the access card, printer management computer 110 may determine that the distance is not greater than the threshold. In other words, according to the second embodiment, the threshold may be based on how close mobile device 140 must be to the access card to communicate with the access card.

At step 404, if the distance is not greater than the threshold, method 400 moves to step 412. Otherwise, if the distance is greater than the threshold, method 400 moves to step 406. At step 406, printer management computer 110 transmits a message to mobile device 140 requesting authorization for using the access card to access printer 150, e.g., to execute a print job, copy job, scan job, or fax job. For example, printer management computer 110 may transmit the message as a push notification to a push notification service associated with printer client application 142, and the push notification service may route the message to printer client application 142. As another example, printer management computer 110 may transmit the message as a text message.

At step 408, mobile device 140 transmits a response to printer management computer 110 indicating whether authorization is granted. For example, printer client application 142 may display a UI with options for either allowing access or denying access. If the user selects the option for allowing access, e.g., by pressing a corresponding button in the UI, mobile device 140 may transmit a response indicating that authorization is granted. If the user selects the option for denying access, e.g., by pressing a different button in the UI, mobile device 140 may transmit a response indicating that authorization is denied.

At step 410, if the message indicates that authorization is granted, method 400 moves to step 412. At step 412, printer management computer 110 transmits a message to printer 150 indicating that authorization is granted, e.g., for executing one or more print jobs, one or more copy jobs, one or more scan jobs, and/or one or more fax jobs. At step 414, printer 150 executes the job(s). For example, printer 150 may execute such jobs upon receiving the authorized message. As another example, printer 150 may unlock a panel thereof in response to the authorized message and then execute such jobs in response to the user selecting them via the panel.

After step 414, method 400 ends. Returning to step 410, if the message from mobile device 140 indicates that authorization is denied, method 400 moves to step 416. At step 416, printer management computer 110 transmits a message to printer 150 indicating that authorization is denied, e.g., for executing one or more print jobs, copy jobs, scan jobs, and/or fax jobs. After step 416, method 400 ends, and printer 150 does not allow the person who presented the access card to execute any jobs. For example, printer 150 may display an error message on the panel indicating that access is denied.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

The embodiments described herein also relate to an apparatus for performing these operations. The apparatus may be specially constructed for required purposes, or the apparatus may be a general-purpose computer selectively activated or configured by a computer program stored in the computer. The embodiments described herein may also be practiced with computer system configurations including mobile computing devices, personal computers, server computers, microprocessor systems, mainframe computers, etc., and combinations thereof, which may communicate across one or more networks.

The embodiments described herein also relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components may be implemented as a combined component. Similarly, structures and functionalities presented as a single component may be implemented as separate components. These and other variations, additions, and improvements may fall within the scope of the appended claims.

What is claimed is:

1. A printer management computer including a processor and memory, wherein the processor executes instructions stored in the memory to enable a user to execute a print job or copy job based on location information, by performing the following steps:
receiving, from a printer, a request to authenticate the user whose access card has been presented at the printer;
determining, in response to the request to authenticate the user, one of: (1) that a first distance between a mobile device of the user and the printer is greater than a threshold or (2) that a second distance between the mobile device and the access card is greater than the threshold;
transmitting, to the mobile device in response to the first or second distance being greater than the threshold, a message requesting authorization for using the access card to access the printer, and then receiving a first response from the mobile device indicating that authorization for using the access card is granted; and
transmitting, to the printer in response to authorization being granted for using the access card, a message indicating that execution of the print job or copy job is authorized.

2. The printer management computer of claim 1, wherein the printer management computer determines that the first distance is greater than the threshold, and the steps further include:
determining a location of the mobile device by communicating with the mobile device;
determining a location of the printer by communicating with the printer; and
determining the first distance by comparing the location of the mobile device to the location of the printer.

3. The printer management computer of claim 2, wherein the steps further include:
receiving a message indicating that the user has authorized the printer management computer to access location information of the mobile device, the printer management computer then determining the location of the mobile device by accessing the location information of the mobile device.

4. The printer management computer of claim 1, wherein the printer management computer determines that the second distance is greater than the threshold, and wherein determining that the second distance is greater than the threshold includes:
transmitting a request to the mobile device to verify the second distance, and then receiving a second response from the mobile device indicating that the second distance is greater than the threshold.

5. The printer management computer of claim 4, wherein the second response indicates that the mobile device is unable to communicate with the access card, and wherein the printer management computer determines that the second distance is greater than the threshold based on the mobile device being unable to communicate with the access card.

6. The printer management computer of claim 1, wherein the request from the printer to authenticate the user includes information from the access card, and the steps further include:
determining, based on the information from the access card, that the access card is registered for using a printer service associated with the printer, the printer management computer determining that the first or second distance is greater than the threshold in response to the access card being registered.

7. The printer management computer of claim 1, wherein the steps further include:
receiving a message indicating that the user has authorized the printer management computer to send push notifications to an application executing on the mobile device, the printer management computer transmitting the message requesting authorization for accessing the printer, to a push notification service associated with the application.

8. A method of enabling a user to execute a print job or copy job based on location information, the method comprising:
receiving, from a printer, a request to authenticate the user whose access card has been presented at the printer;
determining, in response to the request to authenticate the user, one of: (1) that a first distance between a mobile device of the user and the printer is greater than a threshold or (2) that a second distance between the mobile device and the access card is greater than the threshold;
transmitting, to the mobile device in response to the first or second distance being greater than the threshold, a message requesting authorization for using the access card to access the printer, and then receiving a first response from the mobile device indicating that authorization for using the access card is granted; and
transmitting, to the printer in response to authorization being granted for using the access card, a message indicating that execution of the print job or copy job is authorized.

9. The method of claim 8, wherein the printer management computer determines that the first distance is greater than the threshold, the method further comprising:
determining a location of the mobile device by communicating with the mobile device;
determining a location of the printer by communicating with the printer; and
determining the first distance by comparing the location of the mobile device to the location of the printer.

10. The method of claim 9, further comprising:
receiving a message indicating that the user has authorized the printer management computer to access location information of the mobile device, wherein the printer management computer then determines the location of the mobile device by accessing the location information of the mobile device.

11. The method of claim 8, wherein the printer management computer determines that the second distance is greater than the threshold, and wherein determining that the second distance is greater than the threshold includes:
transmitting a request to the mobile device to verify the second distance, and then receiving a second response from the mobile device indicating that the second distance is greater than the threshold.

12. The method of claim 11, wherein the second response indicates that the mobile device is unable to communicate with the access card, and wherein the printer management computer determines that the second distance is greater than the threshold based on the mobile device being unable to communicate with the access card.

13. The method of claim 8, wherein the request from the printer to authenticate the user includes information from the access card, the method further comprising:
determining, based on the information from the access card, that the access card is registered for using a printer service associated with the printer, wherein the printer management computer determines that the first or second distance is greater than the threshold in response to the access card being registered.

14. The method of claim 8, further comprising:
receiving a message indicating that the user has authorized the printer management computer to send push notifications to an application executing on the mobile device, wherein the printer management computer transmits the message requesting authorization for accessing the printer, to a push notification service associated with the application.

15. A non-transitory, computer-readable medium comprising instructions that are executable in a printer management computer, wherein the instructions when executed cause the printer management computer to carry out a method of enabling a user to execute a print job or copy job based on location information, and wherein the method comprises:
receiving, from a printer, a request to authenticate the user whose access card has been presented at the printer;
determining, in response to the request to authenticate the user, one of: (1) that a first distance between a mobile device of the user and the printer is greater than a threshold or (2) that a second distance between the mobile device and the access card is greater than the threshold;
transmitting, to the mobile device in response to the first or second distance being greater than the threshold, a message requesting authorization for using the access card to access the printer, and then receiving a first response from the mobile device indicating that authorization for using the access card is granted; and
transmitting, to the printer in response to authorization being granted for using the access card, a message indicating that execution of the print job or copy job is authorized.

16. The non-transitory, computer-readable medium of claim 15, wherein the printer management computer determines that the first distance is greater than the threshold, and wherein the method further comprises:
determining a location of the mobile device by communicating with the mobile device;
determining a location of the printer by communicating with the printer; and
determining the first distance by comparing the location of the mobile device to the location of the printer.

17. The non-transitory, computer-readable medium of claim 16, wherein the method further comprises:
receiving a message indicating that the user has authorized the printer management computer to access location information of the mobile device, the printer management computer then determining the location of the mobile device by accessing the location information of the mobile device.

18. The non-transitory, computer-readable medium of claim 15, wherein the printer management computer determines that the second distance is greater than the threshold, and wherein determining that the second distance is greater than the threshold includes:
transmitting a request to the mobile device to verify the second distance, and then receiving a second response from the mobile device indicating that the second distance is greater than the threshold.

19. The non-transitory, computer-readable medium of claim 18, wherein the second response indicates that the mobile device is unable to communicate with the access card, and wherein the printer management computer determines that the second distance is greater than the threshold based on the mobile device being unable to communicate with the access card.

20. The non-transitory, computer-readable medium of claim 15, wherein the request from the printer to authenticate the user includes information from the access card, and the method further comprises:
determining, based on the information from the access card, that the access card is registered for using a printer service associated with the printer, the printer management computer determining that the first or second distance is greater than the threshold in response to the access card being registered.
